(19) United States
(12) Patent Application Publication
(10) Pub. No.: US 2026/0045710 A1
(43) Pub. Date: Feb. 12, 2026

(54) SHIELDED CONNECTOR ASSEMBLY FOR BENT CONDUCTORS

(71) Applicant: Aptiv Technologies AG, Schaffhausen (CH)

(72) Inventors: Gert DROESBEKE, Erkrath (DE); Manoharan SRINIVASAN, Chennai (IN); Michael URBACH, Remscheid (DE); Daniel LASZLO, Tatabanya (HU); Juergen LAUSCH, Königsbach (DE)

(21) Appl. No.: 19/270,684

(22) Filed: Jul. 16, 2025

(30) Foreign Application Priority Data
Aug. 7, 2024 (EP) 24193330.8

(51) Int. Cl. H01R 9/05; H01R 4/18

(52) U.S. Cl. CPC H01R 9/0518; H01R 4/185

(57) ABSTRACT

An angled connector assembly includes a connector housing defining an angle, at least two contact terminals configured to receive stripped conductors of a cable, and a cable bending control feature comprising a separate filler insert receivable within the connector housing. The filler insert engages an internal cavity of the housing to support and guide the cable, limiting bending stresses at the interface between the cable and terminals. By providing strain relief and a controlled bend radius, the assembly protects wire terminations against fatigue and damage, thereby enhancing the reliability of electrical connections in angularly oriented cable installations.

### CROSS-REFERENCE TO RELATED APPLICATION

This application claims the benefit of and priority to European Application No. 24193330.8 filed with the European Patent Office on Aug. 7, 2024, the contents of which are incorporated by reference herein.

### TECHNICAL FIELD

The present disclosure generally relates to an angled connector assembly including at least a connector housing, two contact terminals and means for controlling bending of the cable. In particular, the angled connector is designed for high-speed data transfer.

### BACKGROUND

High-speed data transfer connector assemblies are important in various electronic devices and communication systems inside vehicles, where reliable and efficient data transmission is necessary.

When confronted with space constraints, angled connector assemblies may be the preferred choice for the data transfer, particularly 90° connector assemblies.

However, such 90° connector assemblies often result in more components and complexity, and consequently more tolerances, additional differential impedance mismatches, less signal integrity, EMC performance with more variation and higher costs when compared to the version with a straight connector assembly. Furthermore, when such angled connector assemblies are manufactured in a cost competitive manner, they are often confronted with openings in the shielding. As a result, some users have completely redesigned their electrical architecture in order not to include 90° connector assemblies.

In view of the foregoing, there is a need for an improved angled connector assembly, which can ensure high speed data transfer without being too expensive. Therefore, it is an object of the present disclosure to overcome some or all the deficiencies of the prior art, and to propose an angled connector assembly that is dependable and affordable.

### SUMMARY

The above-mentioned object is at least partially realized by an angled connector assembly, in particular an angled 90° connector assembly, according to claim 1 or by a method of assembly of an electrical connector assembly according to claim 15. Preferred embodiments are the subject of the dependent claims, and the skilled person will find clues to other suitable aspects of the present disclosure in the overall disclosure of the present application.

An aspect of the disclosure relates to an angled connector assembly including a connector housing defining the angle, at least two contact terminals, configured to receive stripped conductors of a cable; and means for controlling bending of the cable, wherein the means include at least one separate filler insert, configured to be received in the connector housing.

In contrast to former angled connector assemblies, the angle between the mating interface and the cable axis is not realized by means of specific contact terminals with extra components around them, but instead by the conductors of the cable. This way, compared to a straight connector assembly, the connector assembly only needs minimal extra assembly steps and minimal extra components, thereby keeping the costs low. Additionally, several components from straight connector assemblies can also be used in the angled connector assembly such that higher production quantities, and therefore lower production costs, of these components are possible.

The separate filler element provides for controlling bending, as it may be specifically designed for that purpose. As it is a separate, i.e., independent component and not a part of the connector housing, less design restrictions apply. If the housing is e.g., at least partially made from bend and stamped sheet metal, it is difficult to realize complex interior shapes that would be desirable to control the bending of an installed cable. The present i disclosure thus allows the use of relatively simple shapes for the connector housing, which reduces the costs and complexity of the housing.

Advantageously, the connector housing is electrically conductive and made at least partially from stamped and bent sheet metal. Because the conductors are bent it is necessary to remove the shielding from around the conductors of the cable over a much longer length when compared to a straight connector assembly. To avoid major differential impedance match and return loss, the conductors are preferably enclosed by the metallized connector housing in a kind of tunnel. The connector housing can also include part of the means for controlling bending of the cable. Such means can for example be rounded edges which define the inner radius of the bent conductors, concave segments defining the outer radius of the bent conductors, grooves that keep the conductors in place while bending them, clips holding the bent conductors, etc.

In a preferred embodiment, the separate filler insert is configured to fix the cable in the connector housing. The separate filler insert may for example be fixed to the connector housing, while sandwiching the conductors of the cable between the connector housing and the separate filler insert. Alternatively, the separate filler insert can include means to fix the cable on the filler insert, the filler subsequently being attached to the connector housing.

To ensure that sufficient shielding is provided at the angled connector assembly, the at least one separate filler insert can be made from a dielectric material. By filling up empty spaces within the connector housing with dielectric material the shielding properties are improved. Further, the use of a dielectric material is advantageous as it allows e.g., the manufacturing of the filler element by means of injection molding of a plastic material. Separate fillers inserts can be used in various positions within the connector housing. As such, the separate filler insert may include means designed to define the inner radius of the cable bend when the filler is placed on the inner side of the bend. Such means can for example be rounded edges which define the inner radius of the bent conductors. Similarly, the separate filler insert may include means designed to define the outer radius of the cable bend, such as a concave segment, having grooves holding the conductors in place.

It is of course possible to have two separate filler inserts. These inserts may have a matching shape in which the first separate filler insert includes means designed to define the inner radius of cable bend and the second separate filler insert includes means designed to define the outer radius of the cable bend. The two separate filler inserts together ensure that the space within the connector housing is filled up to improve shielding properties of the connector. The matching shapes of the fillers may be such that the conductors are sandwiched between the two fillers. This is a simple and cheap way to fix the conductors in place while improving the shielding and transfer properties of the connector assembly by adding an additional shielding layer around the conductors at the bend. The bent is particularly vulnerable to interferences or pollution from nearby transmissions because, at this location, the shielding layer of the cable has been folded back around the cable to allow bending of the conductors.

The separate filler insert preferably includes guide grooves configured to receive the cable. The guide grooves can be part of the means for controlling bending, in particular a controlled 90° bending. The guide grooves can also be placed outside of the bending area. Guide grooves make sure that the conductors remain in place during bending and prevent that the conductors glide from the filler when the conductors are bent. If the conductors glide from the filler, they may be folded which worsens transfer properties and therefore result in lower transmission speeds. As such, guide grooves prevent a wrong assembly position and ensure that the connector assembly can be assembled in a speedy fashion without compromising the quality of the end product. The filler can also include holding elements configured to hold the cable in the bent configuration. The holding elements preferably include clipping means designed to clip the cable on the filler insert. Such clipping means allow bending of the conductors while holding them in the correct bending path. As such, guide grooves and holding elements can prevent a wrong assembly position and ensure that the connector assembly can be assembled in a speedy fashion without compromising the quality of the end product.

The angled connector assembly may further include a dielectric cartridge retaining the contact terminals. Because the contact terminals are a weak spot of the assembly and because they are prone to twisting, adding a cartridge can protect the contact terminals while ensuring that the conductors are not twisted, in particular during mounting of the terminals into the connector housing. Such a cartridge also helps to introduce the contact terminals into the connector housing, by increasing their stiffness. The cartridge can optionally include means for a controlled inner radius bending, in particular a controlled 90° bending of the cable, such as rounded edges which define the inner radius of the bent conductors, grooves, clips, etc. This may facilitate the production of the connector housing, which housing consequently does not require to have said means for controlling bending.

A second filler insert can be used to push the cartridge to its ideal position within the connector housing upon mounting and to keep the cartridge in that position when mounted. When the connector housing is closed, the second filler will be pushed into the connector housing, which in turn will push the cartridge in place. This way it is ensured that the cartridge and the filler are in the right assembly position.

The angled connector assembly may further include a dielectric capsule accommodating the cartridge and placed within the connector housing. The dielectric capsule can further improve the shielding of the contact terminals receiving the stripped conductors and moreover keep the terminals in position. The dielectric capsule optionally includes at least part of the means for a controlled inner radius bending of the cable. In some embodiments, the means for a controlled inner radius bending of the cable can be located on the capsule and the cartridge, in other embodiments the means for a controlled inner radius bending can be located on the cartridge and the connector housing, and in yet other embodiments the means for a controlled inner radius bending are located only on the cartridge. Adding the means for a controlled inner radius bending to the capsule can have advantages in the manufacturing process.

The connector housing is advantageously substantially L-shaped, a first branch of the L being configured to accommodate at least part of the contact terminals and a second branch of the L having crimping wings for fixation of cables. Thus, the angled connection is defined by the connector housing. The crimping wings are opened to allowing the insertion of the contact terminals into the first branch of the L. The first branch may also accommodate the cartridge securing the conductors of the cable against twisting, and/or the dielectric capsule. The crimping wings optionally include a first pair of crimping wings designed to secure a shielding braid of the cable and a second pair of crimping wings designed to secure an outer jacket of the cable. Having a pair of crimping wings securing the shielding braid and another pair securing the outer jacket ensures that the crimping force is configured to the thickness of the item to be crimped, ensuring a reliable hold. Consequently, the shielding does not open even when the cable is under traction. Additionally, the crimping wings may overlap when crimped to increase the shielding effect. The second branch of the L may include a third pair of crimping wings designed to secure the second separate filler insert within the connector housing and ensuring that the cable is properly sandwiched between components of the connector assembly. This preferred enhancement works particularly well with the above-mentioned housing made at least partially from bend and stamped sheet metal.

In some embodiments, the connector assembly further includes an outer dielectric shell, such as an outer dielectric housing. This can further protect the whole connector assembly from outer influences and increases in particular the overall robustness and/or watertightness of the assembly. It serves in particular to electrically insulate the electroconductive components of the connector assembly.

The connector assembly is particularly configured for high-speed data transfer, in particular with a data transmission speed of at least 0.5 Gbit/s, preferably 1 GBit/s, more preferably at least 3 Gbit/s, and/or of at most 15 Gbit/s, preferably at most 10 Gbit/s. The connector assembly of the disclosure may achieve beyond 7 GHz on return loss and up to 20 GHz for EMC. According to HESS simulations of a nominal condition, the connector assembly achieves a performance beyond 12 GHZ.

The angled connector assembly preferably includes at least one cable. The cable may be mounted to the angled connector assembly through the stripped conductors received in the contact terminals. Additionally, the connector assembly can include various other means to attach the cable, as mentioned above. The cable can be protected against stripping of the connector assembly by sandwiching it between filler inserts, by clipping it to different components of the connector assembly, by crimping or by the crimping wings of the connector housing, etc.

To assemble the connector housing, at least two contact terminals are connected on respective stripped conductors of the cable. This can occur by crimping or soldering the conductors on the contact terminals. The connected contact terminals are subsequently mounted on the connector housing.

Once the contact terminals are mounted on the housing, the housing itself can be used to support the bending of the cable. Additionally, the connector assembly includes the means for controlling bending, in particular a controlled 90° bending, ensuring that the cables are bent without risking any breakage or fold. To this end, at least one separate filler insert, forming part of the means for controlled bending, in particular a controlled 90° bending, is received in the connector housing.

### BRIEF DESCRIPTION OF THE DRAWINGS

In the following, preferred embodiments of the disclosure are disclosed by reference to the accompanying figure, in which shows:

FIG. 1 shows an exploded view of an angled 90° connector assembly according to some embodiments.

FIGS. 2a to 2f show assembly steps of the angled 90° connector assembly of FIG. 1 according to some embodiments.

FIG. 3 shows a cross section side view of the 90° connector assembly of FIG. 1 according to some embodiments.

FIG. 4a shows an isometric view of a dielectric capsule without mounted terminals according to some embodiments.

FIG. 4b shows an isometric view of a dielectric capsule with mounted terminals according to some embodiments.

FIG. 5 shows cross section side view of a 90° angled connector assembly according to some embodiments.

FIG. 6 shows an isometric view of a separate filler insert according to some embodiments.

FIG. 7 shows a cross section top view of the filler insert of FIG. 6 being mounted inside a connector housing according to some embodiments.

### DETAILED DESCRIPTION

In the following, preferred embodiments of the present disclosure are described in detail with respect to the figures.

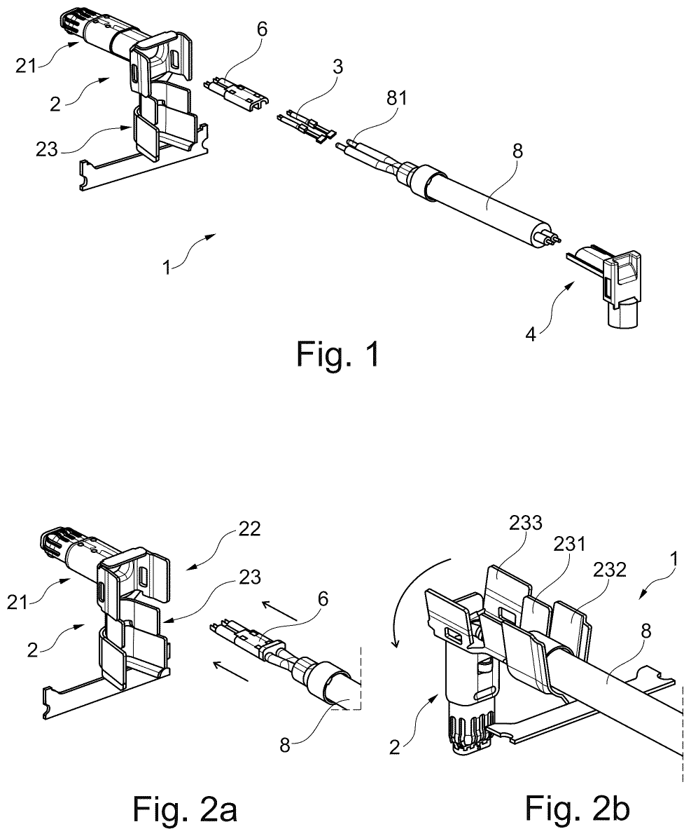

FIG. 1 shows an exploded view of a first preferred embodiment of an angled connector assembly 1, notably a 90° connector assembly. Contact terminals 3 are configured to receive the stripped conductors 81 of a cable 8. Subsequently, the contact terminals can be inserted into cartridge 6. The cartridge 6 includes grooves holding the contact terminals 3 and is inserted into the connector housing 2. The connector housing is made of sheet metal and includes a processing aid at its lower end which is removed in the assembly process. The connector assembly 1 further includes a separate filler insert 4 which includes means for controlling bending of cable 8.

The connector housing 2 is substantially L-shaped. A first branch 21 of the L is configured to accommodate contact terminals 3 and a second branch 22 of the L includes crimping wings 23.

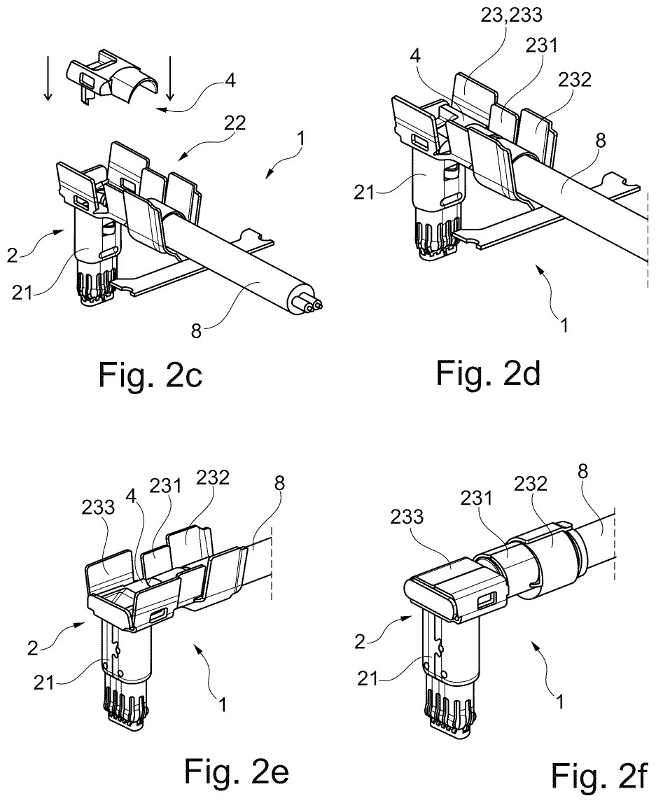

FIG. 2a shows the assembly step where the cartridge 6 with mounted terminals 3 is inserted into the first branch 21 of the connector housing 2. In the first step a, the second branch 22 is open and accessible to receive cable 8 and cartridge 6.

FIG. 2b shows terminals 3 and cartridge 6 inserted in the first branch 21 and the cable 8, respectively the conductors 81 being bent by 90°.

The second branch 22 includes three pairs of crimping wings 23, namely a first pair of crimping wings 231 securing the shielding layer such as a shielding braid of the cable 8, a second pair of crimping wings 232 securing the outer jacket of the cable and a third pair of crimping wings 233, closing the open end of the first branch 21 and securing the filler insert 4 in place.

In the step shown in FIG. 2c, the separate filler insert 4 including means for controlling bending is inserted into the open side of the connector housing 2. The filler insert 4 secures the cable 8 in the connector housing 2 and shields the cable 8.

FIG. 2d shows the separate filler insert 4 within the connector housing 2 at the bend of the cable. The three pairs of crimping wings are still open. Filler 4 controls the 90° bend of cable 8 and secures cable 8 in the shown 90° bend configuration.

FIG. 2e shows the configuration of FIG. 2d from a different angle. In contrast with the connector assembly of the previous figure, in this step the processing aid has been removed from the connector housing 2.

In the last step shown in FIG. 2f, all three pairs of crimping wings are crimped such that the second branch 22 of the connector housing is completely closed. It can be seen that the crimping wings may partially overlap. In this configuration, the assembly is ready for use.

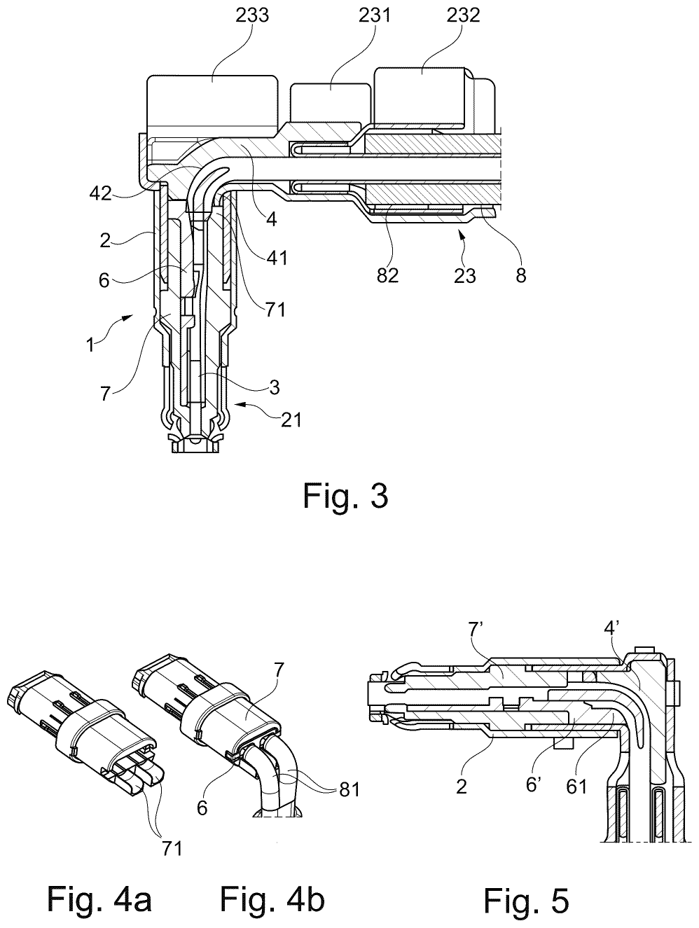

FIG. 3 shows a cross section side view of the connector assembly 1. The cartridge 6 together with terminals 3 and the attached conductors 81 are arranged inside of the first branch 21. One can see how the filler insert 4 forces cable 8 into a 90° configuration. In the area of the bending, the outer jacket 82 of the cable 8 is removed, but the principle would likewise work with the jacket 82 still in place.

The cartridge is arranged inside of an optional dielectric capsule 7, that is shown in more detail in FIG. 4. The dielectric capsule 7 is provided with means 71 for a controlled inner bending of the cable 8. The dielectric capsule 7 thus serves as a separate filler insert to control the interior radius of the bend cable. Similarly, also cartridge 6 could be provided with such bend control means, which would make the cartridge a separate filler insert. This particular design is shown in FIG. 5.

FIGS. 4a and 4b shows an isometric view of the dielectric capsule 7, which includes means 71 defining the inner radius 41. The capsule 7 in FIG. 4a is shown without the cartridge 6 installed and in FIG. 4b, one can see how the cartridge 6 is arranged inside the capsule 7, with the cable 8 being bend by 90° with the help of means 71.

FIG. 5 shows a cross-section side view of another embodiment that differs from the embodiment of FIGS. 1 to 2 mainly in the shape of the separate filler insert 4′ and the cartridge 6′. In the embodiment of FIG. 5, the cartridge 6′ includes the means 61 for a controlled 90° bending of the cable 8, while the capsule 7′ does not include any such means. The filler insert 4′ is very similar to the filler insert 4, except for the upper right corner thereof, which has a slightly different shape. In this way, the filler insert may be chosen corresponding to the interior space inside of the connector housing that needs to be filled.

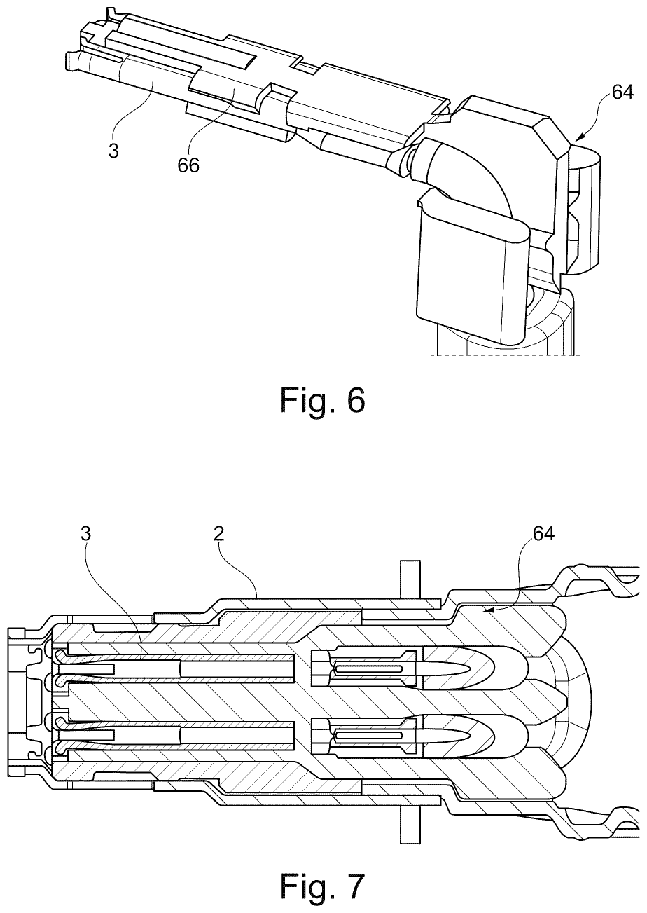

FIG. 6 shows an embodiment of a filler insert 64 with means for controlled 90° bending of the cable, which means are designed to define the inner radius of the bending. The filler insert 64 is integrally formed with a cartridge 66 that is similar to the cartridge 6.

FIG. 7 shows the filler insert 64 in a cross section top view arranged inside of the connector housing 2.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An angled connector assembly, comprising:
a connector housing defining an angle;
at least two contact terminals configured to receive stripped conductors of a cable; and
means for controlling bending of the cable, wherein the means includes a separate filler insert configured to be received in the connector housing.

2. The angled connector assembly according to claim 1, wherein the connector housing is electrically conductive, and made at least partially from stamped and bent sheet metal.

3. The angled connector assembly according to claim 2, wherein the connector housing includes at least part of the means for controlling bending of the cable.

4. The angled connector assembly according to claim 1, wherein the separate filler insert is configured to fix the cable in the connector housing.

5. The angled connector assembly according to claim 1, wherein the separate filler insert is made from a dielectric material.

6. The angled connector assembly according to claim 1, wherein the separate filler insert includes means designed to define an inner radius of the cable bend or means designed to define an outer radius of the cable bend.

7. The angled connector assembly according to claim 6, wherein the separate filler insert includes a first separate filler insert having means configured to define the inner radius of a cable bend and a second separate filler insert including means configured to define the outer radius of the cable bend.

8. The angled connector assembly according to claim 1, wherein the separate filler insert includes guide grooves configured to receive the cable.

9. The angled connector assembly according to claim 1, wherein the separate filler insert includes holding elements configured to hold the cable in a bent configuration.

10. The angled connector assembly according to claim 9, wherein the holding elements include clipping means designed to attach the cable to the filler insert.

11. The angled connector assembly according to claim 1, wherein the angled connector assembly further includes a dielectric cartridge retaining the contact terminals.

12. The angled connector assembly according to claim 11, wherein the cartridge includes means for controlling bending of an inner radius of the cable.

13. The angled connector assembly according to claim 11, wherein a second filler insert is configured to urge the cartridge to its ideal position upon mounting and to keep the cartridge in that position when mounted.

14. The angled connector assembly according to claim 11, further including a dielectric capsule placed within the connector housing accommodating the cartridge.

15. The angled connector assembly according to claim 14, wherein the dielectric capsule includes means for controlling bending of an inner radius of the cable.

16. The angled connector assembly according to claim 1, wherein the connector housing is substantially L-shaped, wherein a first branch of the L-shaped connector housing is configured to accommodate at least part of the contact terminals, and wherein a second branch of the L-shaped connector housing has crimping wings for fixation of the cable.

17. The angled connector assembly according to claim 16, wherein the crimping wings include a first pair of crimping wings designed to secure a shielding layer of the cable and a second pair of crimping wings designed to secure an outer jacket of the cable.

18. The angled connector assembly according to claim 1, further including an outer dielectric shell to electrically insulate electroconductive components of the connector assembly.

19. The angled connector assembly according to claim 1, wherein the connector assembly is configured for high-speed data transfer with a data transmission speed of at least 0.5 Gbit/s.

20. A method of manufacturing an angled connector assembly having a connector housing defining an angle, at least two contact terminals configured to receive stripped conductors of a cable, means for controlling bending of the cable, wherein the means include at least one separate filler insert configured to be received in the connector housing and a cable, the method comprising:
connecting at least two contact terminals on respective stripped conductors of the cable;
mounting the connected contact terminals on the connector housing; and
bending the cable using the means for controlling bending, whereby at least one separate filler insert, forming part of the means for controlled bending, is received in the connector housing.
